(19) United States
(12) Patent Application Publication
(10) Pub. No.: US 2016/0343512 A1
(43) Pub. Date: Nov. 24, 2016

(54) MATRIX ARRANGEMENT STACKED-TYPE SOLID ELECTROLYTIC CAPACITOR PACKAGE STRUCTURE AND METHOD OF MANUFACTURING THE SAME

(71) Applicant: APAQ TECHNOLOGY CO., LTD., Miaoli County (TW)

(72) Inventors: CHI-HAO CHIU, HSINCHU CITY (TW); KUN-HUANG CHANG, HSINCHU CITY (TW)

(21) Appl. No.: 14/809,312

(22) Filed: Jul. 27, 2015

(30) Foreign Application Priority Data
May 22, 2015 (TW) 104116456

(51) Int. Cl. H01G 9/10; H01G 9/28; H01G 9/008; H01G 9/15; H01G 9/00

(52) U.S. Cl. CPC H01G 9/10; H01G 9/15; H01G 9/0029; H01G 9/008; H01G 9/28

(57) ABSTRACT

A matrix arrangement stacked-type solid electrolytic capacitor package structure includes a lead frame component, a plurality of capacitor units, and a package unit. The lead frame component includes a plurality of conductive holders arranged in matrix arrangement and a connection frame connected to the conductive holders. Each conductive holder includes a first conductive terminal and a second conductive terminal. The capacitor units are respectively disposed on the conductive holders. Each capacitor unit includes a plurality of first stacked-type capacitors sequentially stacked on top of one another and electrically connected with each other. Each first stacked-type capacitor has a first positive portion electrically connected to the first conductive terminal of the corresponding conductive holder and a first negative portion electrically connected to the second conductive terminal of the corresponding conductive holder. The package unit includes a plurality of package resin bodies for respectively enclosing the capacitor units.

### BACKGROUND OF THE INVENTION

1. Field of the Invention

The instant disclosure relates to a solid electrolytic capacitor package structure and a method of manufacturing the same, and more particularly to a matrix arrangement stacked-type solid electrolytic capacitor package structure and a method of manufacturing the same.

2. Description of Related Art

Various applications of capacitors include home appliances, computer motherboards and peripherals, power supplies, communication products and automobiles. The capacitors such as solid electrolytic capacitors are mainly used to provide filtering, bypassing, rectifying, coupling, blocking or transforming function. Because the solid electrolytic capacitor has the advantages of small size, large electrical capacitance and good frequency characteristic, it can be used as a decoupling element in the power circuit of a central processing unit (CPU). In general, a plurality of capacitor elements is stacked together to form a stacked solid electrolytic capacitor with a high electrical capacitance. In addition, the stacked solid electrolytic capacitor of the prior art includes a plurality of capacitor elements and a lead frame. Each capacitor element includes an anode part, a cathode part and an insulating part. The insulating part is insulated from the anode part and the cathode part. More specifically, the cathode parts of the capacitor elements are stacked on top of one another.

### SUMMARY OF THE INVENTION

One aspect of the instant disclosure relates to a matrix arrangement stacked-type solid electrolytic capacitor package structure and a method of manufacturing the same for increasing the utilization rate of a lead frame component and decreasing the consumption rate of package resin bodies inside a mold structure, so as to adapt to large scale production.

One of the embodiments of the instant disclosure provides a matrix arrangement stacked-type solid electrolytic capacitor package structure, comprising: a lead frame component, a plurality of capacitor units, and a package unit. The lead frame component includes a plurality of conductive holders arranged in matrix arrangement and a connection frame connected to the conductive holders. Each conductive holder includes a first conductive terminal connected to the connection frame and a second conductive terminal connected to the connection frame and separated from the first conductive terminal by a predetermined distance. The capacitor units are respectively disposed on the conductive holders. Each capacitor unit includes a plurality of first stacked-type capacitors sequentially stacked on top of one another and electrically connected with each other, and each first stacked-type capacitor has a first positive portion electrically connected to the first conductive terminal of the corresponding conductive holder and a first negative portion electrically connected to the second conductive terminal of the corresponding conductive holder. The package unit includes a plurality of package resin bodies for respectively enclosing the capacitor units. More particularly, the first conductive terminal of each conductive holder has a first embedded portion electrically connected to the first positive portion of the first stacked-type capacitor of the corresponding capacitor unit and enclosed by the corresponding package resin body and a first exposed portion connected to the first embedded portion and exposed from the corresponding package resin body. The second conductive terminal of each conductive holder has a second embedded portion electrically connected to the first negative portion of the second stacked-type capacitor of the corresponding capacitor unit and enclosed by the corresponding package resin body and a second exposed portion connected to the second embedded portion and exposed from the corresponding package resin body.

Another one of the embodiments of the instant disclosure provides a matrix arrangement stacked-type solid electrolytic capacitor package structure, comprising: a lead frame component, a plurality of capacitor units, and a package unit. The lead frame component includes a plurality of conductive holders arranged in matrix arrangement and a connection frame connected to the conductive holders, and each conductive holder includes a first conductive terminal connected to the connection frame and a second conductive terminal connected to the connection frame and separated from the first conductive terminal by a predetermined distance. The capacitor units are respectively disposed on the conductive holders. Each capacitor unit includes a plurality of first stacked-type capacitors sequentially stacked on top of one another and electrically connected with each other, and each first stacked-type capacitor has a first positive portion electrically connected to the first conductive terminal of the corresponding conductive holder and a first negative portion electrically connected to the second conductive terminal of the corresponding conductive holder. The package unit includes a plurality of package resin bodies for respectively enclosing the capacitor units. More particularly, the first conductive terminal of each conductive holder has a first embedded portion enclosed by the corresponding package resin body and a first exposed portion connected to the first embedded portion and exposed from the corresponding package resin body. The second conductive terminal of each conductive holder has a second embedded portion enclosed by the corresponding package resin body and a second exposed portion connected to the second embedded portion and exposed from the corresponding package resin body.

Yet another one of the embodiments of the instant disclosure provides a method of manufacturing a matrix arrangement stacked-type solid electrolytic capacitor package structure, comprising: providing a lead frame component, the lead frame component including a plurality of conductive holders arranged in matrix arrangement and a connection frame connected to the conductive holders, each conductive holder including a first conductive terminal connected to the connection frame and a second conductive terminal connected to the connection frame and separated from the first conductive terminal by a predetermined distance; respectively placing a plurality of capacitor units on the conductive holders, each capacitor unit including a plurality of first stacked-type capacitors sequentially stacked on top of one another and electrically connected with each other, and each first stacked-type capacitor having a first positive portion electrically connected to the first conductive terminal of the corresponding conductive holder and a first negative portion electrically connected to the second conductive terminal of the corresponding conductive holder; and then forming a plurality of package resin bodies through a mold structure for respectively enclosing the capacitor units. More particularly, the first conductive terminal of each conductive holder has a first embedded portion electrically connected to the first positive portion of the first stacked-type capacitor of the corresponding capacitor unit and enclosed by the corresponding package resin body and a first exposed portion connected to the first embedded portion and exposed from the corresponding package resin body. The second conductive terminal of each conductive holder has a second embedded portion electrically connected to the first negative portion of the second stacked-type capacitor of the corresponding capacitor unit and enclosed by the corresponding package resin body and a second exposed portion connected to the second embedded portion and exposed from the corresponding package resin body.

Therefore, the utilization rate of the lead frame component is increased and the consumption rate of the package resin bodies inside the mold structure are decreased due to the design of “the lead frame component includes a plurality of conductive holders arranged in matrix arrangement and a connection frame connected to the conductive holders, and each conductive holder includes a first conductive terminal connected to the connection frame and a second conductive terminal connected to the connection frame and separated from the first conductive terminal by a predetermined distance” and “forming a plurality of package resin bodies through a mold structure for respectively enclosing the capacitor units”, so that the matrix arrangement stacked-type solid electrolytic capacitor package structure and a method of manufacturing the same can be adapted to large scale production.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a flowchart of a method of manufacturing a matrix arrangement stacked-type solid electrolytic capacitor package structure according to the instant disclosure;

FIG. 2 shows a schematic view of a lead frame component of the matrix arrangement stacked-type solid electrolytic capacitor package structure according to the instant disclosure;

FIG. 3 shows an enlarged view taken on part A of FIG. 2;

FIG. 4 shows an enlarged, schematic view of the manufacturing step S102 of the method of manufacturing a matrix arrangement stacked-type solid electrolytic capacitor package structure according to the instant disclosure;

FIG. 5 shows an enlarged, schematic view of the manufacturing step S104 of the method of manufacturing a matrix arrangement stacked-type solid electrolytic capacitor package structure according to the instant disclosure;

FIG. 6 shows a schematic view of a mold structure used by the matrix arrangement stacked-type solid electrolytic capacitor package structure according to the instant disclosure;

FIG. 7 shows a lateral, cross-sectional, schematic view of a single first stacked-type capacitor or a single second stacked-type capacitor of the matrix arrangement stacked-type solid electrolytic capacitor package structure according to the instant disclosure;

FIG. 8 shows a lateral, cross-sectional, schematic view of the matrix arrangement stacked-type solid electrolytic capacitor package structure using a plurality of first stacked-type capacitors according to the instant disclosure; and

FIG. 9 shows a lateral, cross-sectional, schematic view of the matrix arrangement stacked-type solid electrolytic capacitor package structure using a plurality of first stacked-type capacitors and a plurality of second stacked-type capacitors according to the instant disclosure.

### DETAILED DESCRIPTION OF THE PREFERRED EMBODIMENTS

The embodiments of “a matrix arrangement stacked-type solid electrolytic capacitor package structure and a method of manufacturing the same” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

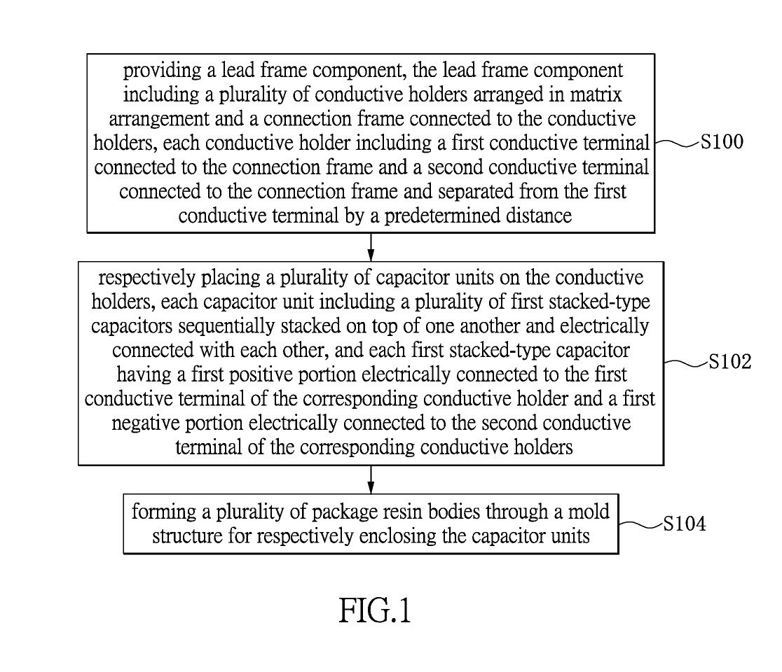

Referring to FIG. 1 to FIG. 8, the instant disclosure provides a method of manufacturing a matrix arrangement stacked-type (or chip-type) solid electrolytic capacitor package structure Z, comprising the following steps:

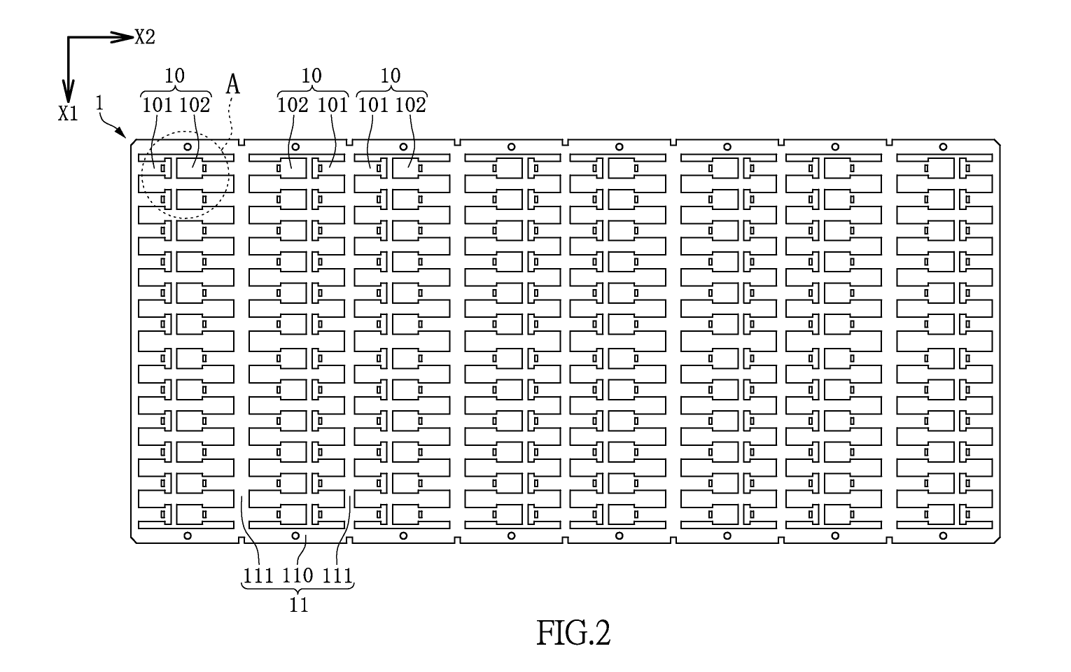

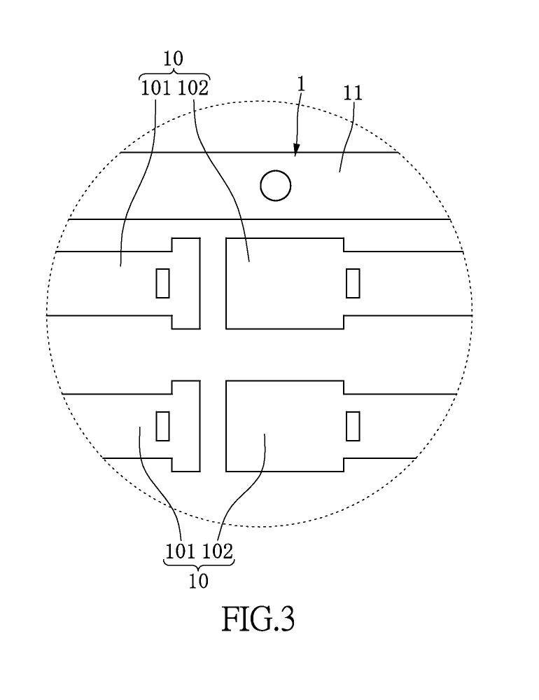

First, referring to FIG. 1, FIG. 2, and FIG. 3, the step S100 is: providing a lead frame component 1 (such as a lead frame), the lead frame component 1 including a plurality of conductive holders (supports) 10 arranged in matrix arrangement and a connection frame 11 connected to the conductive holders 10, each conductive holder 10 including a first conductive terminal 101 connected to the connection frame 11 and a second conductive terminal 102 connected to the connection frame 11 and separated from the first conductive terminal 101 by a predetermined distance. More particularly, the connection frame 11 has a surrounding frame portion 110 and a plurality of connection portions 111 connected with the surrounding frame portion 110 and surrounded by the surrounding frame portion 110. In addition, a first predetermined horizontal direction X1 and a second predetermined horizontal direction X2 are vertical to each other, any two adjacent first conductive terminals 101 or any two adjacent second conductive terminals 102 horizontally extended along the first predetermined horizontal direction X1 are separated from each other, and any two adjacent first conductive terminals 101 or any two adjacent second conductive terminals 102 horizontally extended along the second predetermined horizontal direction X2 are connected with each other through the connection frame 11 and symmetrically disposed on opposite sides of the corresponding connection portion 111.

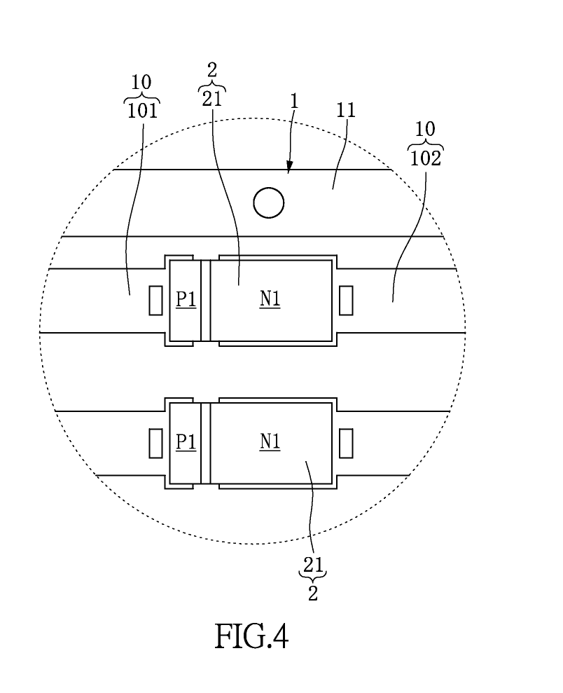

Next, referring to FIG. 1, FIG. 3, and FIG. 4, the step S102 is: respectively placing a plurality of capacitor units 2 on the conductive holders 10, each capacitor unit 2 including a plurality of first stacked-type capacitors 21 sequentially stacked on top of one another and electrically connected with each other, and each first stacked-type capacitor 21 having a first positive portion P1 electrically connected to the first conductive terminal 101 of the corresponding conductive holder 10 and a first negative portion N1 electrically connected to the second conductive terminal 102 of the corresponding conductive holders 10.

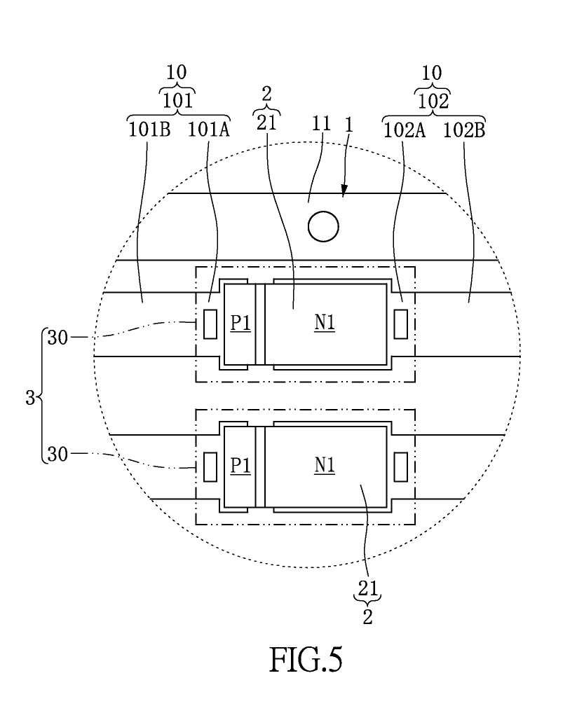

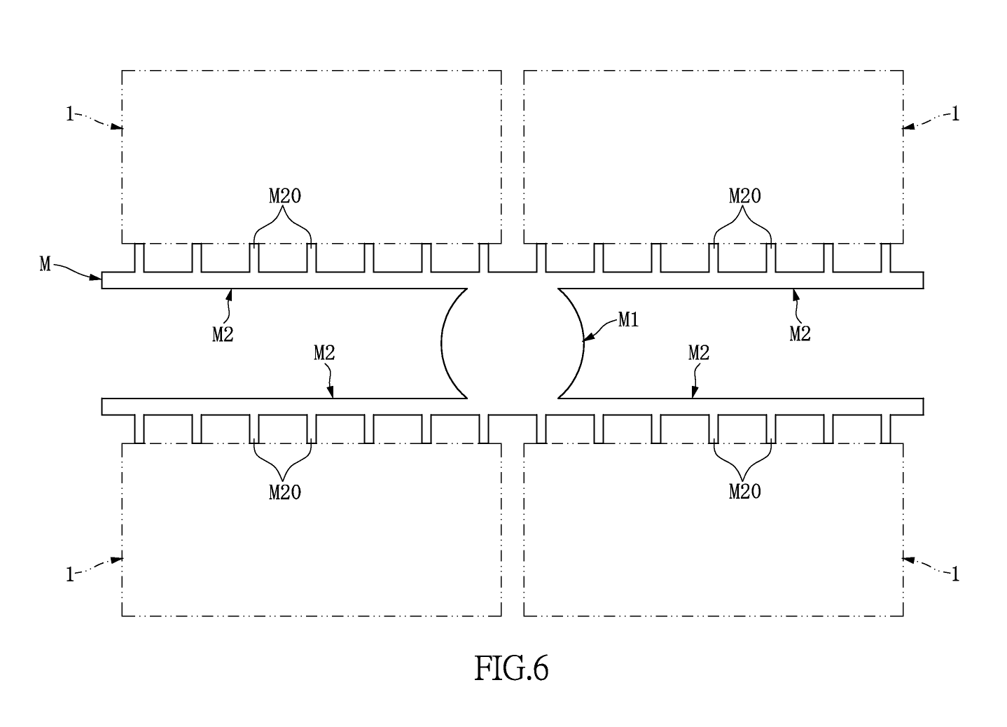

Then, referring to FIG. 1, FIG. 5, and FIG. 6, the step S104 is: forming a plurality of package resin bodies 30 through a mold structure M for respectively enclosing the capacitor units 2. For example, as shown in FIG. 6, the mold structure M includes a major flow channel M1 and at least four minor flow channels M2 communicated with the major flow channel M1, and each minor flow channel M2 has a plurality of resin injection passages M20 extended along the same direction. In addition, the resin injection passages M20 of each minor flow channel M2 correspond to the lead frame component 1, so that the package resin body 30 (such as opaque package material) can sequentially passes through the major flow channel M1, and the corresponding minor flow channels M2 and the resin injection passages M20 thereof to partially enclose the lead frame component 1. In other words, because the resin injection passages M20 of any one of the minor flow channels M2 can correspond to the lead frame component 1, the package resin body 30 can sequentially passes through the major flow channel M1, the corresponding minor flow channels M2, and the resin injection passages M20 to partially enclose the corresponding lead frame component 1.

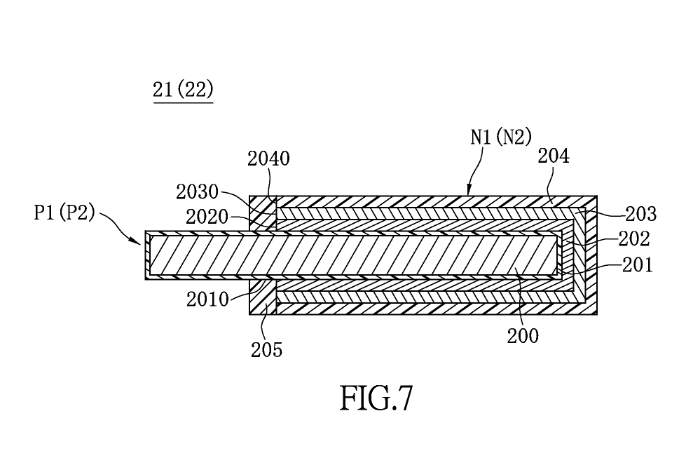

Therefore, referring to FIG. 2, FIG. 5, and FIG. 7, the instant disclosure further provides a matrix arrangement stacked-type solid electrolytic capacitor package structure Z, comprising: a lead frame component 1, a plurality of capacitor units 2, and a package unit 3. The lead frame component 1 includes a plurality of conductive holders 10 arranged in matrix arrangement and a connection frame 11 connected to the conductive holders 10, and each conductive holder 10 includes a first conductive terminal 101 connected to the connection frame 11 and a second conductive terminal 102 connected to the connection frame 11 and separated from the first conductive terminal 101 by a predetermined distance. Moreover, the capacitor units 2 are respectively disposed on the conductive holders 10. Each capacitor unit 2 includes a plurality of first stacked-type capacitors 21 sequentially stacked on top of one another and electrically connected with each other, and each first stacked-type capacitor 21 has a first positive portion P1 electrically connected to the first conductive terminal 101 of the corresponding conductive holder 10 and a first negative portion N1 electrically connected to the second conductive terminal 102 of the corresponding conductive holder 10. In addition, the package unit 3 includes a plurality of package resin bodies 30 for respectively enclosing (encapsulating) the capacitor units 30.

More particularly, as shown in FIG. 5, the first conductive terminal 101 of each conductive holder 10 has a first embedded portion 101A electrically connected to the first positive portion P1 of the first stacked-type capacitor 21 (that is to say, the first embedded portion 101A is electrically connected to the first positive portion P1 of the bottommost first stacked-type capacitor 21) of the corresponding capacitor unit 2 and enclosed by the corresponding package resin body 30 and a first exposed portion 101B connected to the first embedded portion 101A and exposed from and outside the corresponding package resin body 30. In addition, the second conductive terminal 102 of each conductive holder 10 has a second embedded portion 102A electrically connected to the first negative portion N1 of the second stacked-type capacitor 21 (that is to say, the second embedded portion 102A is electrically connected to the first negative portion N1 of the bottommost first stacked-type capacitor 21) of the corresponding capacitor unit 2 and enclosed by the corresponding package resin body 30 and a second exposed portion 102B connected to the second embedded portion 102A and exposed from the corresponding package resin body 30.

More particularly, as shown in FIG. 7, each first stacked-type capacitor 21 includes a valve metal foil 200, an oxide insulation layer 201 for enclosing the valve metal foil 200, a conductive polymer layer 202 for covering one portion of the oxide insulation layer 201, a carbon paste layer 203 for enclosing the conductive polymer layer 202, and a silver paste layer 204 for enclosing the carbon paste layer 203. In addition, each first stacked-type capacitor 21 has a surrounding insulating layer 205 disposed on the outer surface of the oxide insulation layer 201 and around the outer surface of the oxide insulation layer 201, and the lengths of the conductive polymer layer 202, the carbon paste layer 203, and the silver paste layer 204 of each first stacked-type capacitor 21 are limited by the corresponding surrounding insulating layer 205. Furthermore, the oxide insulation layer 201 has a surrounding region 2010 formed on the outer surface thereof, and the surrounding insulating layer 205 of each first stacked-type capacitor 21 is surroundingly disposed on the surrounding region 2010 of the corresponding oxide insulation layer 201 and contacting an end 2020 of the corresponding conductive polymer layer 202, an end 2030 of the corresponding carbon paste layer 203, and an end 2040 of the corresponding silver paste layer 204. However, the first stacked-type capacitor 21 used in the instant disclosure is merely an example and is not meant to limit the instant disclosure.

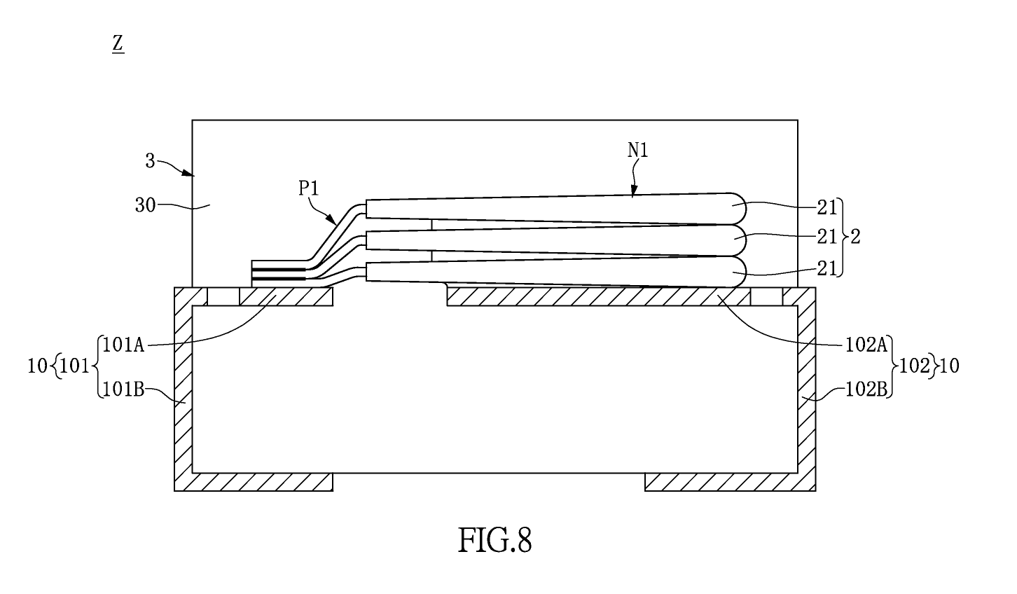

Please note, referring to FIG. 5 and FIG. 8, after cutting the lead frame component 1, both the first exposed portion 101B and the second exposed portion 102B can be bent along an outer surface of the package resin body 30 to form the matrix arrangement stacked-type solid electrolytic capacitor package structure Z. More particularly, the two first negative portions N1 of the two adjacent first stacked-type capacitors 21 are stacked on top of one another by silver paste (no label), and the two first positive portions P1 of the two adjacent first stacked-type capacitors 21 are stacked on top of one another by a soldering layer (no label).

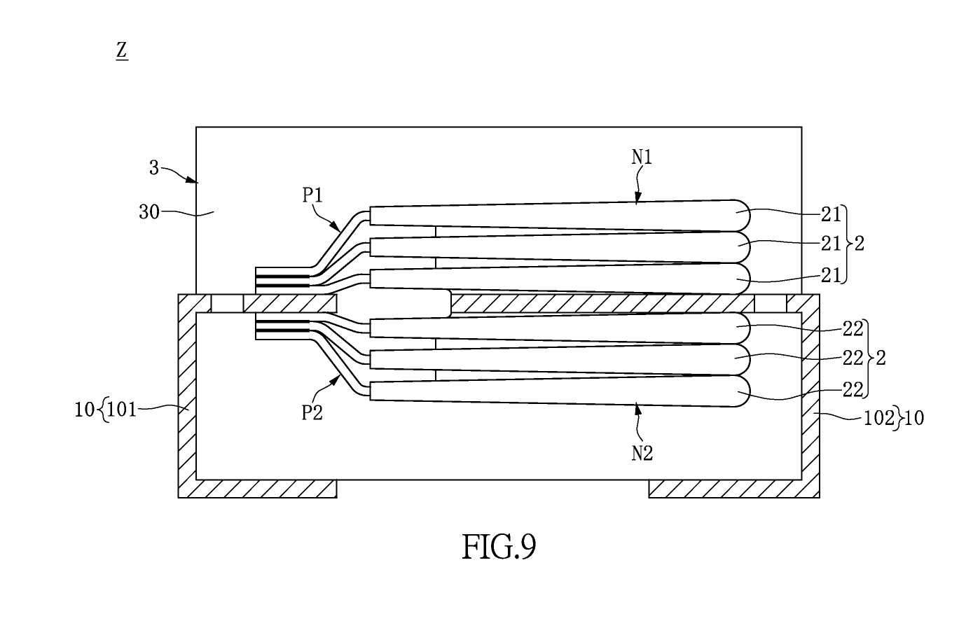

Please note, referring to FIG. 9, the capacitor unit 2 further includes a plurality of second stacked-type capacitors 22 sequentially stacked on top of one another and electrically connected with each other, and each second stacked-type capacitor 22 has a second positive portion P2 electrically connected to the first conductive terminal 101 of the corresponding conductive holder 10 and a second negative portion N2 electrically connected to the second conductive terminal 102 of the corresponding conductive holder 10. In addition, the first stacked-type capacitors 21 of each capacitor unit 2 are disposed on a top surface of the corresponding conductive holder 10, and the second stacked-type capacitors 22 of each capacitor unit 2 are disposed on a bottom surface of the corresponding conductive holder 10.

More particularly, as shown in FIG. 7, each second stacked-type capacitors 22 includes a valve metal foil 200, an oxide insulation layer 201 for enclosing the valve metal foil 200, a conductive polymer layer 202 for covering one portion of the oxide insulation layer 201, a carbon paste layer 203 for enclosing the conductive polymer layer 202, and a silver paste layer 204 for enclosing the carbon paste layer 203. In addition, each second stacked-type capacitors 22 has a surrounding insulating layer 205 disposed on the outer surface of the oxide insulation layer 201 and around the outer surface of the oxide insulation layer 201, and the lengths of the conductive polymer layer 202, the carbon paste layer 203, and the silver paste layer 204 of each second stacked-type capacitors 22 are limited by the corresponding surrounding insulating layer 205. Furthermore, the oxide insulation layer 201 has a surrounding region 2010 formed on the outer surface thereof, and the surrounding insulating layer 205 of each second stacked-type capacitors 22 is surroundingly disposed on the surrounding region 2010 of the corresponding oxide insulation layer 201 and contacting an end 2020 of the corresponding conductive polymer layer 202, an end 2030 of the corresponding carbon paste layer 203, and an end 2040 of the corresponding silver paste layer 204. However, the second stacked-type capacitor 22 used in the instant disclosure is merely an example and is not meant to limit the instant disclosure.

In conclusion, the utilization rate of the lead frame component 1 is increased and the consumption rate of the package resin bodies 30 inside the mold structure M are decreased due to the design of “the lead frame component 1 includes a plurality of conductive holders 10 arranged in matrix arrangement and a connection frame 11 connected to the conductive holders 10, and each conductive holder 10 includes a first conductive terminal 101 connected to the connection frame 11 and a second conductive terminal 102 connected to the connection frame 11 and separated from the first conductive terminal 101 by a predetermined distance” and “forming a plurality of package resin bodies 30 through a mold structure M for respectively enclosing the capacitor units 2”, so that the matrix arrangement stacked-type solid electrolytic capacitor package structure Z and a method of manufacturing the same can be adapted to large scale production.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A matrix arrangement stacked-type solid electrolytic capacitor package structure, comprising:
a lead frame component including a plurality of conductive holders arranged in matrix arrangement and a connection frame connected to the conductive holders, wherein each conductive holder includes a first conductive terminal connected to the connection frame and a second conductive terminal connected to the connection frame and separated from the first conductive terminal by a predetermined distance;
a plurality of capacitor units respectively disposed on the conductive holders, wherein each capacitor unit includes a plurality of first stacked-type capacitors sequentially stacked on top of one another and electrically connected with each other, and each first stacked-type capacitor has a first positive portion electrically connected to the first conductive terminal of the corresponding conductive holder and a first negative portion electrically connected to the second conductive terminal of the corresponding conductive holder; and
a package unit including a plurality of package resin bodies for respectively enclosing the capacitor units;
wherein the first conductive terminal of each conductive holder has a first embedded portion electrically connected to the first positive portion of the first stacked-type capacitor of the corresponding capacitor unit and enclosed by the corresponding package resin body and a first exposed portion connected to the first embedded portion and exposed from the corresponding package resin body;
wherein the second conductive terminal of each conductive holder has a second embedded portion electrically connected to the first negative portion of the second stacked-type capacitor of the corresponding capacitor unit and enclosed by the corresponding package resin body and a second exposed portion connected to the second embedded portion and exposed from the corresponding package resin body.

2. The matrix arrangement stacked-type solid electrolytic capacitor package structure of claim 1, wherein the connection frame has a surrounding frame portion and a plurality of connection portions connected with the surrounding frame portion and surrounded by the surrounding frame portion, any two adjacent first conductive terminals or any two adjacent second conductive terminals horizontally extended along a first predetermined horizontal direction are separated from each other, any two adjacent first conductive terminals or any two adjacent second conductive terminals horizontally extended along a second predetermined horizontal direction are connected with each other through the connection frame and symmetrically disposed on opposite sides of the corresponding connection portion, and the first predetermined horizontal direction and the second predetermined horizontal direction are vertical to each other.

3. The matrix arrangement stacked-type solid electrolytic capacitor package structure of claim 1, wherein each first stacked-type capacitor includes a valve metal foil, an oxide insulation layer enclosing the valve metal foil, a conductive polymer layer covering one portion of the oxide insulation layer, a carbon paste layer enclosing the conductive polymer layer, and a silver paste layer enclosing the carbon paste layer, wherein each first stacked-type capacitor has a surrounding insulating layer disposed on the outer surface of the oxide insulation layer and around the outer surface of the oxide insulation layer, and the lengths of the conductive polymer layer, the carbon paste layer, and the silver paste layer of each first stacked-type capacitor are limited by the corresponding surrounding insulating layer, wherein the oxide insulation layer has a surrounding region formed on the outer surface thereof, and the surrounding insulating layer of each first stacked-type capacitor is surroundingly disposed on the surrounding region of the corresponding oxide insulation layer and contacting an end of the corresponding conductive polymer layer, an end of the corresponding carbon paste layer, and an end of the corresponding silver paste layer.

4. The matrix arrangement stacked-type solid electrolytic capacitor package structure of claim 1, wherein the capacitor unit includes a plurality of second stacked-type capacitors sequentially stacked on top of one another and electrically connected with each other, and each second stacked-type capacitor has a second positive portion electrically connected to the first conductive terminal of the corresponding conductive holder and a second negative portion electrically connected to the second conductive terminal of the corresponding conductive holder, wherein the first stacked-type capacitors of each capacitor unit are disposed on a top surface of the corresponding conductive holder, and the second stacked-type capacitors of each capacitor unit are disposed on a bottom surface of the corresponding conductive holder.

5. The matrix arrangement stacked-type solid electrolytic capacitor package structure of claim 4, wherein each second stacked-type capacitor includes a valve metal foil, an oxide insulation layer enclosing the valve metal foil, a conductive polymer layer covering one portion of the oxide insulation layer, a carbon paste layer enclosing the conductive polymer layer, and a silver paste layer enclosing the carbon paste layer, wherein each second stacked-type capacitor has a surrounding insulating layer disposed on the outer surface of the oxide insulation layer and around the outer surface of the oxide insulation layer, and the lengths of the conductive polymer layer, the carbon paste layer and the silver paste layer of each second stacked-type capacitor are limited by the corresponding surrounding insulating layer, wherein the oxide insulation layer has a surrounding region formed on the outer surface thereof, and the surrounding insulating layer of each second stacked-type capacitor is surroundingly disposed on the surrounding region of the corresponding oxide insulation layer and contacting an end of the corresponding conductive polymer layer, an end of the corresponding carbon paste layer, and an end of the corresponding silver paste layer.

6. A matrix arrangement stacked-type solid electrolytic capacitor package structure, comprising:
a lead frame component including a plurality of conductive holders arranged in matrix arrangement and a connection frame connected to the conductive holders, wherein each conductive holder includes a first conductive terminal connected to the connection frame and a second conductive terminal connected to the connection frame and separated from the first conductive terminal by a predetermined distance;
a plurality of capacitor units respectively disposed on the conductive holders, wherein each capacitor unit includes a plurality of first stacked-type capacitors sequentially stacked on top of one another and electrically connected with each other, and each first stacked-type capacitor has a first positive portion electrically connected to the first conductive terminal of the corresponding conductive holder and a first negative portion electrically connected to the second conductive terminal of the corresponding conductive holder; and
a package unit including a plurality of package resin bodies for respectively enclosing the capacitor units;
wherein the first conductive terminal of each conductive holder has a first embedded portion enclosed by the corresponding package resin body and a first exposed portion connected to the first embedded portion and exposed from the corresponding package resin body;
wherein the second conductive terminal of each conductive holder has a second embedded portion enclosed by the corresponding package resin body and a second exposed portion connected to the second embedded portion and exposed from the corresponding package resin body.

7. A method of manufacturing a matrix arrangement stacked-type solid electrolytic capacitor package structure, comprising:
providing a lead frame component, wherein the lead frame component includes a plurality of conductive holders arranged in matrix arrangement and a connection frame connected to the conductive holders, each conductive holder includes a first conductive terminal connected to the connection frame and a second conductive terminal connected to the connection frame and separated from the first conductive terminal by a predetermined distance;
respectively placing a plurality of capacitor units on the conductive holders, wherein each capacitor unit includes a plurality of first stacked-type capacitors sequentially stacked on top of one another and electrically connected with each other, and each first stacked-type capacitor has a first positive portion electrically connected to the first conductive terminal of the corresponding conductive holder and a first negative portion electrically connected to the second conductive terminal of the corresponding conductive holder; and
forming a plurality of package resin bodies through a mold structure for respectively enclosing the capacitor units;
wherein the first conductive terminal of each conductive holder has a first embedded portion electrically connected to the first positive portion of the first stacked-type capacitor of the corresponding capacitor unit and enclosed by the corresponding package resin body and a first exposed portion connected to the first embedded portion and exposed from the corresponding package resin body;
wherein the second conductive terminal of each conductive holder has a second embedded portion electrically connected to the first negative portion of the second stacked-type capacitor of the corresponding capacitor unit and enclosed by the corresponding package resin body and a second exposed portion connected to the second embedded portion and exposed from the corresponding package resin body.

8. The method of claim 7, wherein the connection frame has a surrounding frame portion and a plurality of connection portions connected with the surrounding frame portion and surrounded by the surrounding frame portion, any two adjacent first conductive terminals or any two adjacent second conductive terminals horizontally extended along a first predetermined horizontal direction are separated from each other, any two adjacent first conductive terminals or any two adjacent second conductive terminals horizontally extended along a second predetermined horizontal direction are connected with each other through the connection frame and symmetrically disposed on opposite sides of the corresponding connection portion, and the first predetermined horizontal direction and the second predetermined horizontal direction are vertical to each other.

9. The method of claim 7, wherein each first stacked-type capacitor includes a valve metal foil, an oxide insulation layer enclosing the valve metal foil, a conductive polymer layer covering one portion of the oxide insulation layer, a carbon paste layer enclosing the conductive polymer layer, and a silver paste layer enclosing the carbon paste layer, wherein each first stacked-type capacitor has a surrounding insulating layer disposed on the outer surface of the oxide insulation layer and around the outer surface of the oxide insulation layer, and the lengths of the conductive polymer layer, the carbon paste layer, and the silver paste layer of each first stacked-type capacitor are limited by the corresponding surrounding insulating layer, wherein the oxide insulation layer has a surrounding region formed on the outer surface thereof, and the surrounding insulating layer of each first stacked-type capacitor is surroundingly disposed on the surrounding region of the corresponding oxide insulation layer and contacting an end of the corresponding conductive polymer layer, an end of the corresponding carbon paste layer, and an end of the corresponding silver paste layer.

10. The method of claim 7, wherein the mold structure includes a major flow channel and at least four minor flow channels communicated with the major flow channel, each minor flow channel has a plurality of resin injection passages extended along the same direction, the resin injection passages of one of the minor flow channels correspond to the lead frame component, and the package resin body sequentially passes through the major flow channel, and one of the minor flow channels and the resin injection passages thereof to partially enclose the lead frame component.
